(19) United States
(12) Patent Application Publication
(10) Pub. No.: US 2016/0328670 A1
(43) Pub. Date: Nov. 10, 2016

(54) PREDICTING EFFECTS OF CLIMATE CHANGE ON SUPPLY CHAIN PERFORMANCE

(71) Applicant: INTERNATIONAL BUSINESS MACHINES CORPORATION, ARMONK, NY (US)

(72) Inventors: CONSTANTIN M. ADAM, YORKTOWN HEIGHTS, NY (US); SHANG Q GUO, YORKTOWN HEIGHTS, NY (US); JOHN J. ROFRANO, YORKTOWN HEIGHTS, NY (US); LLOYD A. TREINISH, YORKTOWN HEIGHTS, NY (US); MAJA VUKOVIC, YORKTOWN HEIGHTS, NY (US); FREDERICK WU, YORKTOWN HEIGHTS, NY (US); SAl ZENG, YORKTOWN HEIGHTS, NY (US)

(21) Appl. No.: 14/703,592

(22) Filed: May 4, 2015

(51) Int. Cl. G06Q 10/06; G01W 1/10

(52) U.S. Cl. CPC G06Q 10/06315; G01W 1/10; G06Q 10/067

(57) ABSTRACT

A method for predicting effects of climate change on supply chain performance includes receiving a global climate change model, a supply chain model, and at least one element model. A regional climate model modeling local weather is generated using the global climate model. A first supply chain performance is simulated using the supply chain model, the element model and the regional climate model. One or more extreme weather events are forecasted using the regional climate model. A second supply chain performance is simulated using the supply chain model and the forecasted extreme weather events. A score is determined for the supply chain performance.

### TECHNICAL FIELD

Exemplary embodiments of the inventive concept relate to supply chain performance, and more particularly, exemplary embodiments of the inventive concept relate to a method for predicting the effects of climate change on supply chain performance.

### DISCUSSION OF THE RELATED ART

A global climate change model (GCCM) may model global climate over time. A GCCM may be used, for example, to model global climate over time for the entire world or a large portion thereof. A GCCM is not specific to a particular region of the globe. Thus, a GCCM is not used to model climate change and its effects in local weather for a particular region of interest.

Global climate change is likely to impact local weather in regions of the globe that may be of interest. Such changes may be referred to herein as regional climate changes. Supply chain performance may be affected by regional climate change.

### SUMMARY

According to an exemplary embodiment of the inventive concept, a method for predicting effects of climate change on supply chain performance includes receiving a global climate change model modeling global climate over time. The method includes receiving a supply chain model modeling procurement of at least one product from at least one location and receiving at least one element model modeling how a change in local weather affects the procurement of the at least one product. The method includes generating a regional climate model modeling local weather for the at least one location based on the received global climate model. The method includes simulating a first supply chain performance using the supply chain model, the received at least one element model and the generated regional climate model. The method includes forecasting one or more extreme weather events based on the generated regional climate model. The method includes simulating a second supply chain performance using the supply chain model and the forecasted one or more extreme weather events. The method further includes determining a score for the supply chain performance in light of the received global climate change model based on the first and second supply chain performance simulations.

According to an exemplary embodiment of the inventive concept, generating the regional climate model based on the received global climate model may include downscaling the global climate model.

According to an exemplary embodiment of the inventive concept, the regional climate model may include estimates for temperature and precipitation and the at least one element model may predict effects on the procurement of the at least one product for the estimated temperature and precipitation.

According to an exemplary embodiment of the inventive concept, the forecasting of the one or more extreme weather events may include calculating a probability of occurrence and probability of severity for each of a list of potential extreme weather events, and wherein the score for the supply chain performance may be probabilistic.

According to an exemplary embodiment of the inventive concept, the list of potential extreme weather events may include a cyclone, tornado, hurricane, avalanche, blizzard, drought, or flood.

According to an exemplary embodiment of the inventive concept, the forecasting of the one or more extreme weather events may include retrieving historical weather data and retrieving historical weather-related damage data.

According to an exemplary embodiment of the inventive concept, the forecasting of the one or more extreme weather events may include retrieving social analytics.

According to an exemplary embodiment of the inventive concept, a method for predicting effects of climate change on supply chain performance includes receiving a first global climate change model modeling global climate over time and receiving a second global climate change model modeling global climate over time. The method includes receiving a supply chain model modeling procurement of at least one product from at least one location and receiving at least one element model modeling how a change in local weather affects the procurement of the at least one product. The method includes generating a first regional climate model modeling local weather for the at least one location based on the received first global climate model. The method includes generating a second regional climate model modeling local weather for the at least one location based on the received second global climate model. The method includes simulating a first long-term supply chain performance using the supply chain model, the received at least one element model and the generated first regional climate model and simulating a second long-term supply chain performance using the supply chain model, the received at least one element model and the generated second regional climate model. The method includes forecasting a first set of one or more extreme weather events based on the generated first regional climate model and forecasting a second set of one or more extreme weather events based on the generated second regional climate model. The method includes simulating a first extreme-weather supply chain performance using the supply chain model and the first forecasted set of one or more extreme weather events and simulating a second extreme-weather supply chain performance using the supply chain model and the second forecasted set of one or more extreme weather events. The method includes determining a first score for the supply chain performance in light of the received first global climate change model based on the first long-term supply chain performance and the first extreme-weather supply chain performance. The method includes determining a second score for the supply chain performance in light of the received second global climate change model based on the second long-term supply chain performance and the second extreme-weather supply chain performance. The method further includes calculating a change in supply chain performance score based on the determined first and second scores for the supply chain performance.

According to an exemplary embodiment of the inventive concept, calculating a change in supply chain performance score may include calculating a sensitivity of a supply chain simulation results to a global climate change model.

According to an exemplary embodiment of the inventive concept, generating the regional climate models based on the received global climate models may include downscaling the global climate models.

According to an exemplary embodiment of the inventive concept, the regional climate models may include estimates for temperature and precipitation and the at least one element model may predict effects on the procurement of the at least one product for the estimated temperature and precipitation.

According to an exemplary embodiment of the inventive concept, the forecasting of the one or more extreme weather events may include calculating a probability of occurrence and probability of severity for each of a list of potential extreme weather events, wherein the first score for the supply chain performance may be probabilistic and second score for the supply chain performances may be probabilistic.

According to an exemplary embodiment of the inventive concept, the forecasting of the one or more extreme weather events may include retrieving historical weather data and retrieving historical weather-related damage data.

According to an exemplary embodiment of the inventive concept, the forecasting of the one or more extreme weather events may include retrieving social analytics.

According to an exemplary embodiment of the inventive concept, a method for predicting effects of climate change on supply chain performance includes receiving a global climate change model modeling global climate over time. The method includes receiving a first supply chain model modeling procurement of at least one product from at least one location, and receiving a second supply chain model modeling procurement of at least one product from at least one location. The method includes receiving at least one element model modeling how a change in local weather affects the procurement of the at least one product of the first supply chain model and receiving at least one element model modeling how a change in local weather affects the procurement of the at least one product of the second supply chain model. The method includes generating a first regional climate model modeling local weather for the at least one location of the first supply chain model based on the received global climate model. The method includes generating a second regional climate model modeling local weather for the at least one location of the second supply chain model based on the received global climate model. The method includes simulating a first long-term supply chain performance using the first supply chain model, the received at least one element model for the first supply chain model and the generated first regional climate model. The method includes simulating a second long-term supply chain performance using the second supply chain model, the received at least one element model for the second supply chain model and the generated second regional climate model. The method includes forecasting a first set of one or more extreme weather events based on the first generated regional climate model and forecasting a second set of one or more extreme weather events based on the second generated regional climate model. The method includes simulating a first extreme-weather supply chain performance using the first supply chain model and the forecasted first set of one or more extreme weather events. The method includes simulating a second extreme-weather supply chain performance using the second supply chain model and the forecasted second set of one or more extreme weather events. The method includes determining a first score for the first supply chain performance in light of the received global climate change model based on the first long-term supply chain performance and the first extreme-weather supply chain performance. The method includes determining a second score for the second supply chain performance in light of the received global climate change model based on the second long-term supply chain performance and the second extreme-weather supply chain performance. The method further includes calculating a change in supply chain performance score based on the determined first and second scores for the supply chain performance.

According to an exemplary embodiment of the inventive concept, generating the regional climate models based on the received global climate model may include downscaling the global climate model, and wherein the at least one location of the first supply chain model may include a geographical location that may be different from a geographical location of the at least one location of the second supply chain model.

According to an exemplary embodiment of the inventive concept, the regional climate models may include estimates for temperature and precipitation and the at least one element model may predict effects on the procurement of the at least one product for the estimated temperature and precipitation.

According to an exemplary embodiment of the inventive concept, the forecasting of the one or more extreme weather events may include calculating a probability of occurrence and probability of severity for each of a list of potential extreme weather events, wherein the first score for the first supply chain performance may be probabilistic and the second score for the second supply chain performance may be probabilistic.

According to an exemplary embodiment of the inventive concept, the forecasting of the one or more extreme weather events may include retrieving historical weather data and retrieving historical weather-related damage data.

According to an exemplary embodiment of the inventive concept, the forecasting of the one or more extreme weather events may include retrieving social analytics.

### BRIEF DESCRIPTION OF THE DRAWINGS

The above and other features and aspects of the inventive concept will become more apparent by describing in detail exemplary embodiments thereof with reference to the accompanying drawings, in which:

FIG. 1 is a flow chart of a method for predicting effects of climate change on a supply chain performance according to an exemplary embodiment of the inventive concept;

FIG. 2A is a block diagram illustrating a supply chain containing a plurality of supply chain elements obtaining at least one product from at least one location according to an exemplary embodiment of the inventive concept;

FIG. 2B is a block diagram illustrating a supply chain containing a plurality of supply chain elements obtaining at least one product from at least one location according to an exemplary embodiment of the inventive concept;

FIG. 2C is a block diagram illustrating a supply chain containing a plurality of supply chain elements obtaining at least one product from at least one location according to an exemplary embodiment of the inventive concept;

FIG. 3 is a diagram illustrating an element model modeling how a change in temperature and rainfall may affect the production of vegetables from a vegetable farm according to an exemplary embodiment of the inventive concept;

FIG. 4A is a diagram illustrating predicted summer season rainfall according to an exemplary embodiment of the inventive concept;

FIG. 4B is a diagram illustrating a simulated effect of rainfall change on summer vegetable output according to an exemplary embodiment of the inventive concept;

FIG. 4C is a diagram illustrating a predicted probability of severe summer storms according to an exemplary embodiment of the inventive concept;

FIG. 4D is a diagram illustrating a simulated effect of storm damage on summer produce according to an exemplary embodiment of the inventive concept;

FIG. 4E is a diagram illustrating a combined effect on order fill rate according to an exemplary embodiment of the inventive concept;

FIG. 5 is a flow chart of a method for predicting effects of climate change on a supply chain performance according to an exemplary embodiment of the inventive concept;

FIG. 6A is a diagram illustrating predicted probability of summer season rainfall below 12 inches according to an exemplary embodiment of the inventive concept;

FIG. 6B is a diagram illustrating a simulated probability of crop production reduction of 50% according to an exemplary embodiment of the inventive concept;

FIG. 6C is a diagram illustrating a predicted probability of summer storms according to an exemplary embodiment of the inventive concept;

FIG. 6D is a diagram illustrating a simulated probability of crop loss from storm damage being greater than 50% according to an exemplary embodiment of the inventive concept;

FIG. 6E is a diagram illustrating a probability of fill rate below 80% according to an exemplary embodiment of the inventive concept;

FIG. 7 illustrates a flow chart of a method for predicting effects of climate change on a supply chain performance, according to an exemplary embodiment of the inventive concept; and

FIG. 8 illustrates an example of a computer system capable of implementing the method and apparatus according to embodiments of the present disclosure.

### DETAILED DESCRIPTION OF THE EMBODIMENTS

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The flowcharts and/or block diagrams in the figures illustrate the architecture, functionality, and operation of possible implementations of systems, methods, and computer program products according to various exemplary embodiments of the inventive concept. In this regard, each block in the flowchart or block diagrams may represent a module, segment, or portion of instructions, which comprises one or more executable instructions for implementing the specified logical function(s). In alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

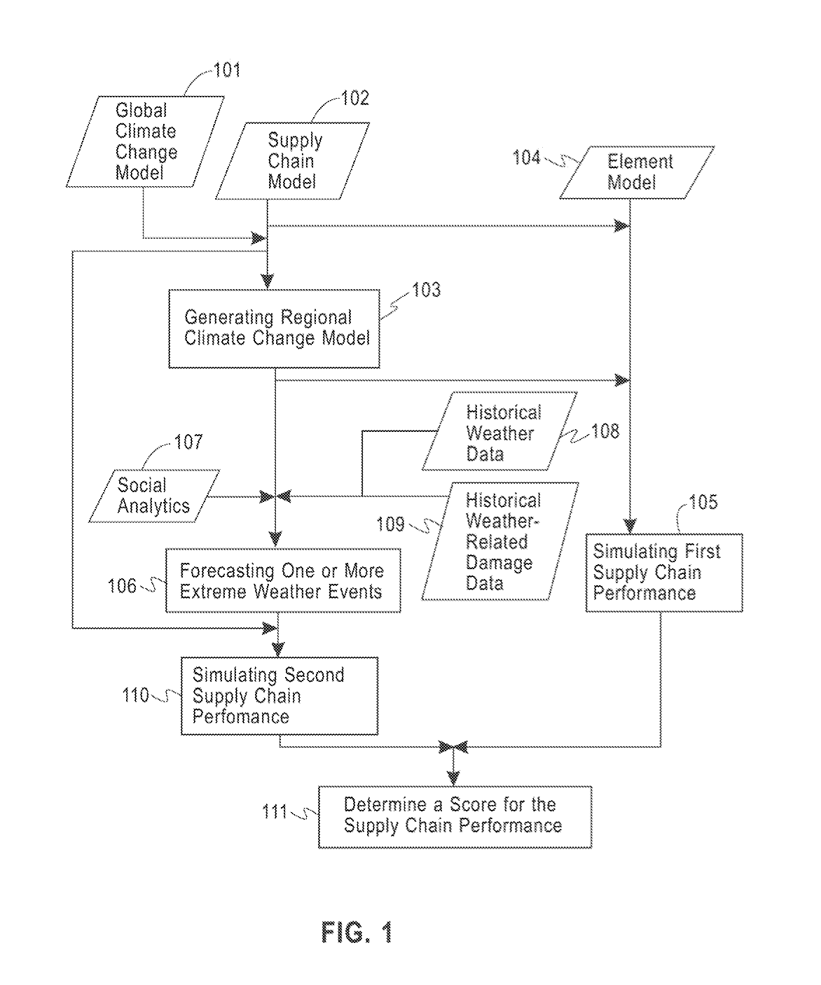

FIG. 1 illustrates a flow chart of a method for predicting effects of climate change on a supply chain performance according to an exemplary embodiment of the inventive concept.

A method for predicting effects of climate change on a supply chain performance, according to an exemplary embodiment of the inventive concept, may include receiving a global climate change model (GCCM) which may be used to model (e.g., predict) global climate over time. Information regarding what a supply chain model may include and how it may operate, and an element model which may be used to indicate how the supply chain model may perform under the predicted global climate may be received.

Supply chain performance may be simulated to indicate how a supply chain may perform, focusing the GCCM to a physical location of the supply chain (e.g., by generating a regional climate model by downscaling the GCCM).

Two supply chain performances may be simulated for the same supply chain model. A first supply chain performance may indicate how the supply chain may perform under the predicted climate change and a second supply chain performance may indicate how the supply chain model may perform under predicted extreme weather events.

The first and second supply chain simulations may be used to determine a score for the supply chain performance.

The method for predicting effects of climate change on a supply chain performance includes receiving a GCCM 101 which may model global climate over time. The GCCM 101 may include a mathematical model that may describe the physics of the atmosphere. The mathematical model, for example, may account for energy added by the sun, gas rising from a surface, and convection, which may cause wind. The mathematical model may use a four-dimensional grid which may include latitude, longitude, altitude, and time.

A GCCM may be created by casting the four-dimensional grid, containing squares, over the surface area of the globe. Each square may correspond to the area of the globe over which it is cast and may define the spatial resolution of the GCCM. Climate predictions may be made by resolving the mathematical model for each square. However, the area of the globe corresponding to each square of the grid may be too large (e.g., several hundred square miles).

The method includes receiving a supply chain model 102 which may model procurement of at least one product from at least one location. For example, the supply chain model 102 may represent a web of organizations, people, activities, and resources (e.g., supply chain elements of a supply chain) that may procure at least one product from at least one location. The supply chain model 102 may also represent a plurality of supply chain elements, for example, raw material producers, that may produce at least one product from at least one location. However, the supply chain model may also model procurement and/or production of a plurality of products from a plurality of locations.

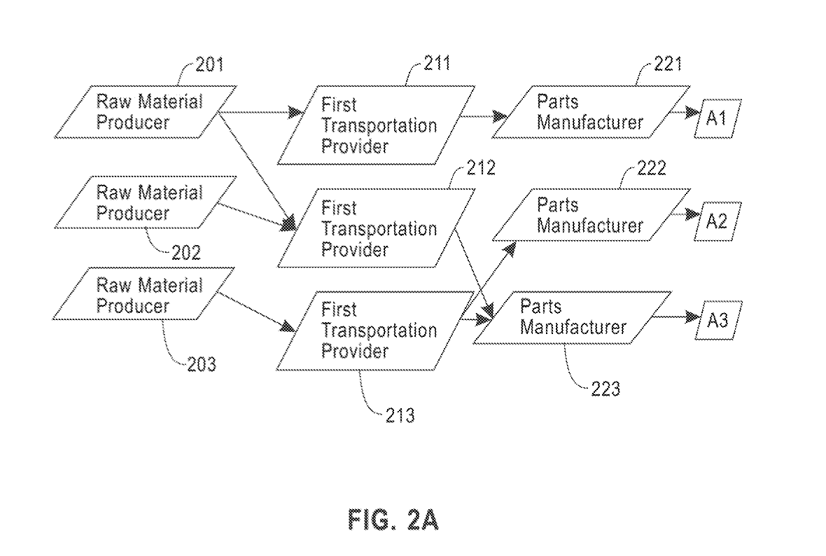

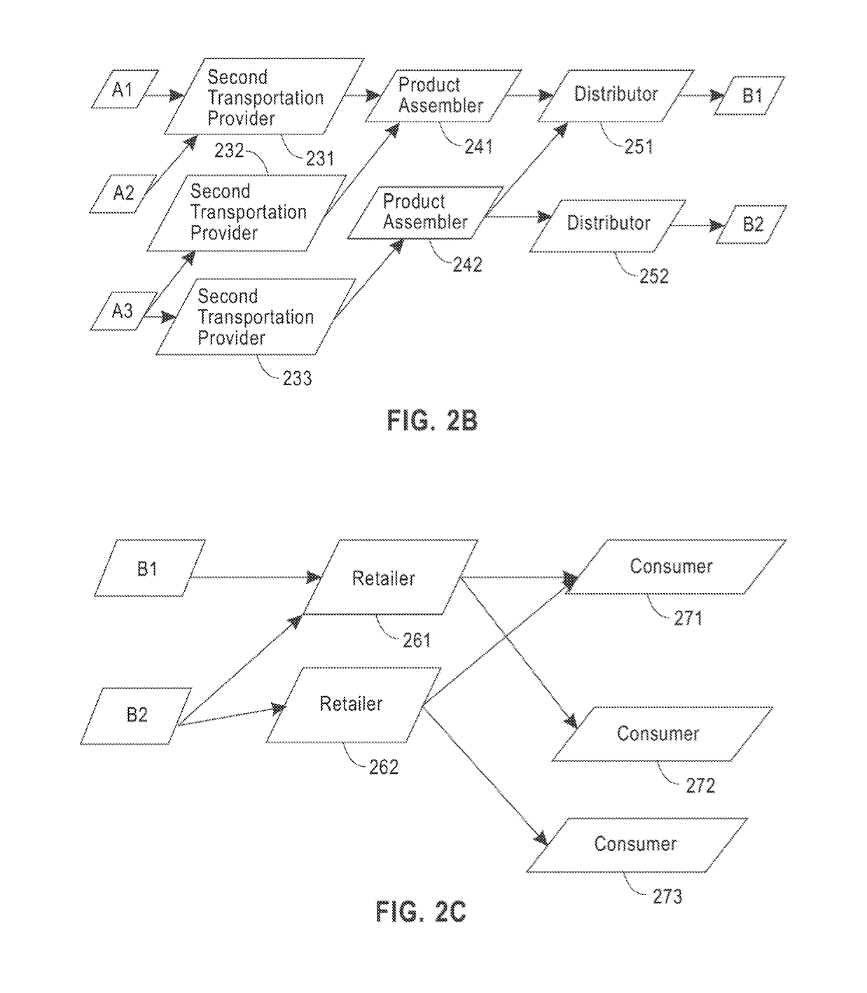

Referring to FIGS. 2A, 2B and 2C, the supply chain model 102, for example, may model production of raw material (e.g., product) from a raw material producer 201 and procurement of raw material from a first transportation provider 211. The supply chain model 102 may include procurement of raw material from a parts manufacturer 221, procurement of a manufactured part from a second transportation provider 231 and procurement of the manufactured part from a product assembler 241. The supply chain model 102 may include procurement of an assembled product from a distributor 251, procurement of the assembled product from a retailer 261 and procurement of the assembled product from a consumer 271. The supply chain element model 102, may include a supply chain element such as the raw material producer 201 which may produce raw material for a plurality of chain elements such as the first transportation provider 211 and the first transportation provider 212. A first transportation provider 213 may procure at least one product from a raw material producer 203. Also, a parts manufacturer 223 may procure one type of raw material (e.g., vegetables) from a first transportation provider 213 and another type of raw material (e.g., copper) from the first transportation provider 212. A parts manufacturer 222 may procure at least one product from the first transportation provider 213. The second transportation provider 231 may also procure at least one product from the parts manufacturer 222. A second transportation provider 232 may procure at least one product from the parts manufacturer 223. A second transportation provider 233 may procure at least one product from parts manufacturer 223. The product assembler 241 may also procure at least one product from the second transportation provider 232. A product assembler 242 may procure at least one product from the second transportation provider 233. The distributor 251 may also procure at least one product from the product assembler 242. The distributor 252 may procure at least one product from the product assembler 242. The retailer 261 may also procure at least one product from the distributor 262. A retailer 262 may procure at least one product from the distributor 252. The consumer 271 may also procure at least one product from the retailer 262. A consumer 272 may procure at least one product from the retailer 261. A consumer 273 may procure at least one product from the retailer 262.

However, exemplary embodiments of the inventive concept are not to be limited to the above disclosure.

The method includes generating a regional climate model 103 which may model local weather for at least one location such as the physical location of the vegetable farm of the raw material producer 203 based on the received GCCM 101. For example, the regional climate model 103 may include a climate model for a limited area of interest that is much smaller than an area covered by one square of a GCCM grid, such as the physical location of the vegetable farm of the raw material producer 203. The regional climate model 103 may be based on the GCCM 101. The regional climate model 103 may include estimates for temperature and precipitation and may be generated by downscaling the GCCM 101.

Downscaling may be used to generate locally relevant climate data from a GCCM. Downscaling a GCCM may be used to increase the spatial resolution of the GCCM and may be applied spatially and temporally. Downscaling a GCCM may include dynamical downscaling and statistical downscaling.

Dynamical downscaling may result in a climate model including a higher spatial resolution than the resolution of the GCCM which it is based on. However, dynamical downscaling may include inputting large volumes of data and performing numerous and/or complex calculations.

Statistical downscaling may use statistical regressions to create a regional climate model having a higher spatial resolution than the resolution of the GCCM which it is based on. Statistical downscaling may use historical climate records. Thus, the quality of historical records may affect the quality of statistical downscaling.

The regional climate change model 103 may include temperatures and precipitation for a desired year or time frame for the vegetable farm of the raw material producer 203.

The method includes receiving at least one element model 104 which may model how a change in local weather may affect the procurement or production of at least one product (e.g., the vegetables produced by the raw material producer 203). An element model may be a physical model and may be manually created. The element model 104 may model how a change in local weather may affect the procurement or production of at least one product such as the vegetables from the vegetable farm of the raw material producer 203 using estimated temperatures and precipitation.

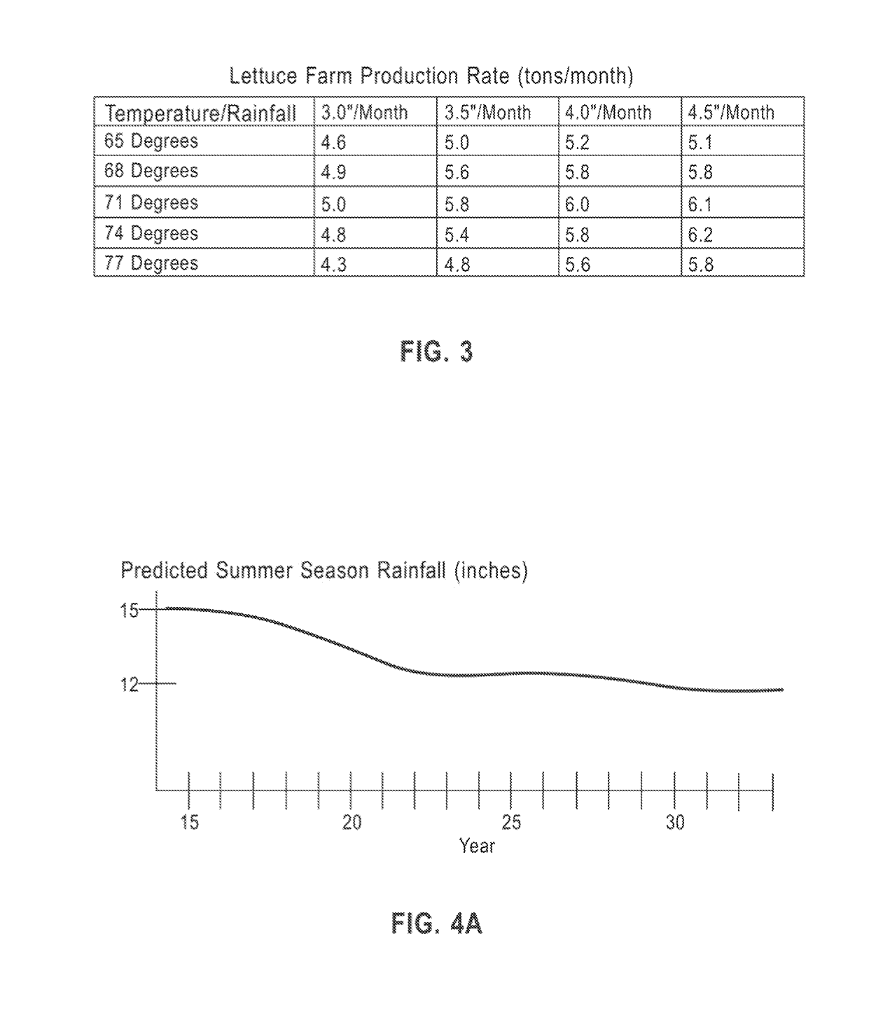

FIG. 3 illustrates the element model 104. The element model 104 data is provided merely to provide an example of data that an element model may contain. The element model 104 data illustrated in FIG. 3 does not represent data that is used in an actual exemplary embodiment of the inventive concept.

The element model 104 may be generated by recording actual field data such as weather data including temperature and precipitation in conjunction with the performance of a desired chain element such as, for example, vegetable production. The element model 104 may also be generated by a technical research or engineering study. An element model may indicate a correlation between weather data and an element chain performance and may be created manually. For example, in April of a given year, an actual field measured temperature and rainfall amount at a farm location may be recorded and an amount of vegetables actually produced by the farm may also be recorded for the corresponding temperature and rainfall amount. Then, in May of the same year, field temperature, rainfall data, and actual production of vegetables is also recorded. This gathered information may generate the element model and may be used to create a correlation between weather data and a supply chain performance under the weather data (e.g., vegetable production). This gathered information may also be used to predict future supply chain performance under similar weather conditions.

The element model 104 may also be created by a technical research or engineering study which may project a supply chain performance, for example, production of vegetables, using input such as a type of vegetable that will be produced, soil conditions, estimated weather data for a desired time period, sunlight exposure, and other data that may be of relevance to the particular element model. However, element models are not limited to the described examples and may be created for various supply chains located in various physical locations and subjected to various types of weather conditions.

The element model 104 illustrated in FIG. 3 may model vegetable production of the raw material producer 203 using temperature and precipitation. The element model 104 may model how a change in temperature and precipitation may affect production of lettuce from the vegetable farm of the raw material producer 203. For example, at a temperature of 68 degrees Fahrenheit and 3.5 inches of rainfall per month, 5.6 tons of lettuce may be produced per month. However, at a temperature of 68 degrees Fahrenheit and 4 inches of rainfall per month, 5.8 tons of lettuce per month may be produced from the lettuce farm.

The quantity of vegetables that may be procured from the vegetable farm of the raw material producer 203 may correspond to the quantity of vegetables that may be produced in the vegetable farm of the raw material producer 203. However, the quantity of vegetables that may be procured from the vegetable farm of the raw material producer 203 may not be exactly equal to the quantity of vegetables that the vegetable farm may produce. The quantity of vegetables that may be procured from the vegetable farm of the raw material producer 203, for example, may be less than the quantity of vegetables that may be produced due to damage done to the vegetables during harvesting.

The element model 104 is not limited to the example described above. The element model 104 may contain a plurality of element models which may correspond to a single or a plurality of supply chain elements of a supply chain.

The element model 104 may also model how a change in local weather affects the procurement of at least one product from at least one supply chain element of a supply chain. For example, the element model 104 may model barge shipping volumes for a barge traveling on a river according to a given river water level. The barge may correspond to, for example, the first transportation provider 211 illustrated in FIG. 2. For example, the barge may ship 2,550 ton-miles per month the river water level is 15 inches below an average river water level. The barge may ship 3,000 ton-miles per month when the river water level is 10 inches below the average river water level. The barge may ship 3,600 ton-miles per month when the river water level is 5 inches below the average river water level and 4,750 ton-miles per month when the river water level corresponds to the average river water level height. The barge may ship 4,400 ton-miles per month when the river water level is 5 inches above the average river water level and 3,500 ton-miles per month when the river water level is 10 inches above the average river water level. The barge may ship 0 ton-miles per month when the river water level is 15 inches above the average river water level.

The method includes simulating a first supply chain performance 105 using the supply chain model 102, the element model 104, and the generated regional climate model 101. The first supply chain performance 105 may mimic an operation of a supply chain element of the supply chain model 102, and may indicate how the supply chain may perform using the supply chain model 102, the element model 104, and the regional climate model 103. Simulating the first supply chain performance 105 may include simulating discrete events and predicting how a supply chain may perform with demand and supply variability and with changes in weather. Simulating the first supply chain performance 105 may include simulating long-term effects of climate change.

Simulating a first supply chain performance 105 may include simulating a supply chain element's inventory turns, cycle time, fill rate, perfect order rate, back order rate, rate or return, or the like. However, simulating a first supply chain 105 is not limited simulating the supply chain element metrics above.

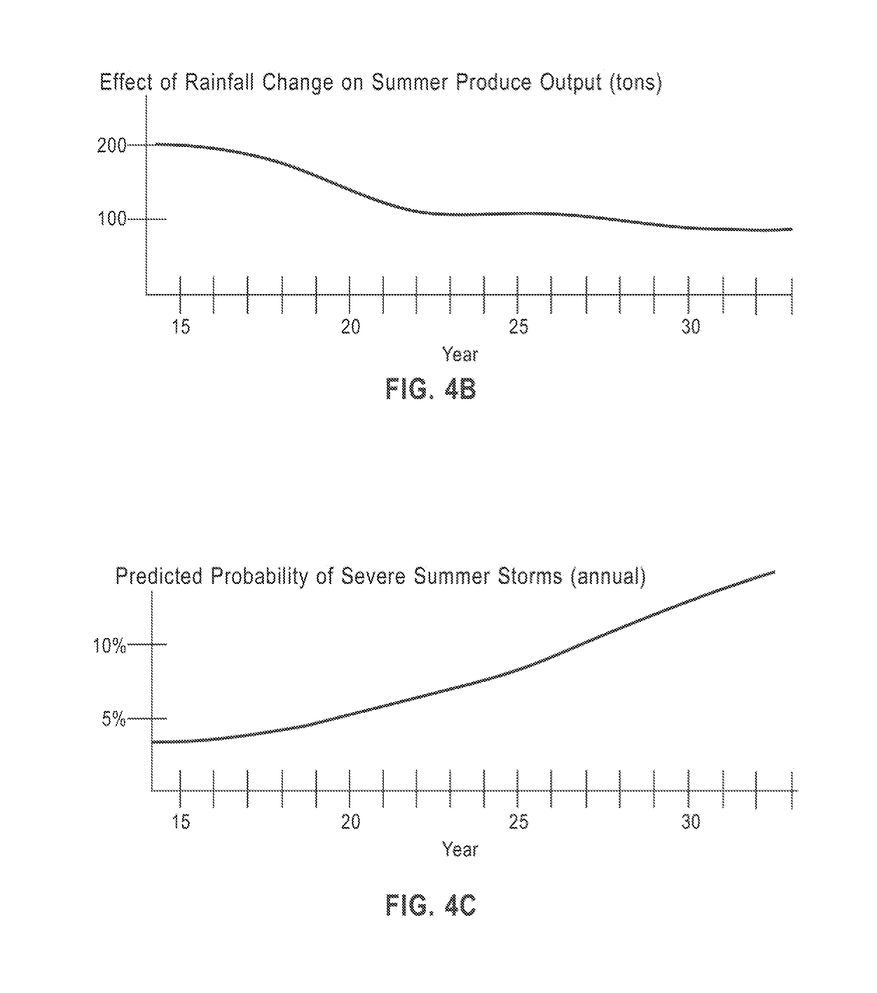

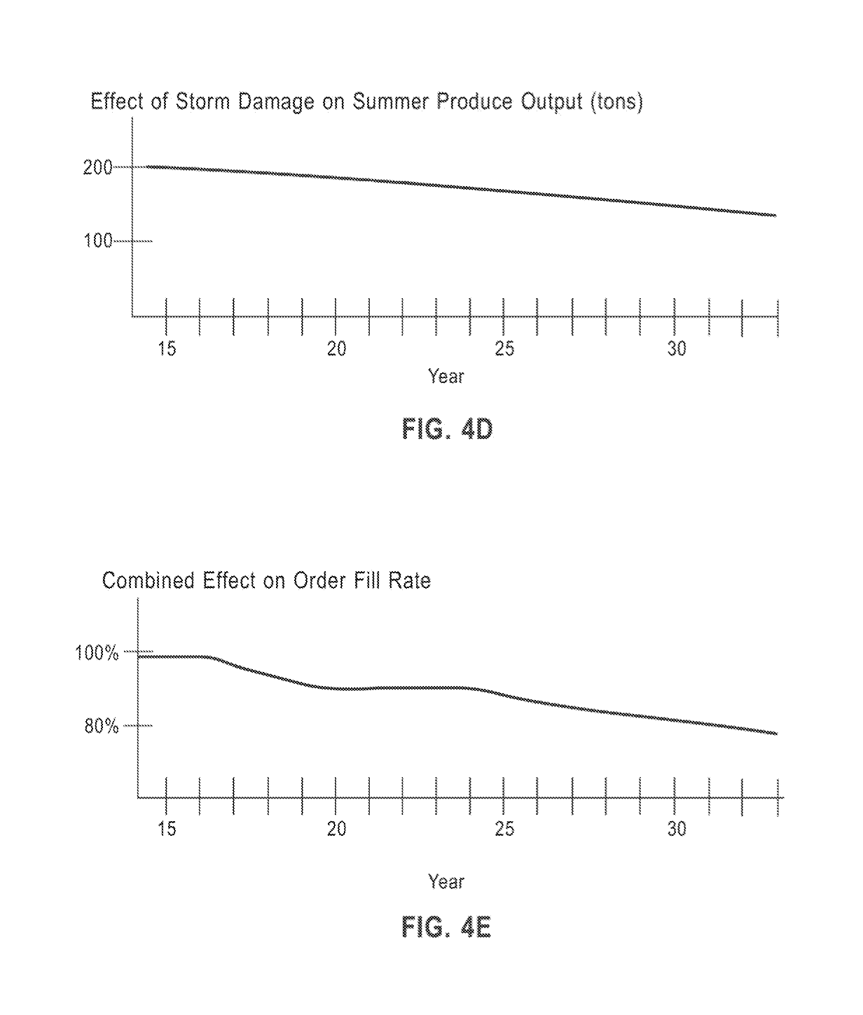

Referring to FIG. 2, FIG. 4A and FIG. 4B, the raw material producer 203 provides 200 tons of vegetables to the first transportation provider 213 each summer. Demand is flat and the supply chain model 102 is not changed over time. As shown in FIG. 4A, summer season rainfall, in inches, for the physical location of the vegetable farm of the raw material producer 203 may be predicted for a desired time period in a graph format using the generated regional climate model 103. For example, approximately 15 inches of rainfall are predicted for the summer of year 2015, but between 10 inches and 14 inches of rainfall are predicted for the summer of year 22. Then, the first supply chain performance 105, as shown in FIG. 4B, may simulate the performance (e.g., production of vegetables) of the raw material producer 203 using the regional climate model 103, predicting summer rainfall as shown in FIG. 4A, the element model 104, modeling how a change in local weather affects the production of vegetables of the raw material producer 203, and the supply chain model 102, indicating flat demand.

Referring to FIG. 4B, the first supply chain performance 105 simulation indicates that approximately 200 tons of vegetables may be produced and procured from the raw material producer 203 in year 15, but between 70 and 130 tons of vegetables may be produced in year 22.

The first supply chain performance 105 may simulate the performance of each of a plurality of supply chain elements of a supply chain model. For example, the first supply chain performance 105 may simulate the performance of the raw material producer 203, the first transportation provider 213, the parts manufacturer 222, the second transportation provider 231, the product assembler 241, the distributor 251, the retailer 261, and the consumer 271.

The method includes forecasting one or more extreme weather events 106, associated with climate change, based on the generated regional climate model 103. An extreme weather event may include a rare or record-breaking weather event such as a cyclone, tornado, hurricane, avalanche, blizzard, drought, flood, or the like, and may have a large impact on a supply chain performance. Forecasting an extreme weather event 106 may include calculating a probability of occurrence and a probability of severity for each of the extreme weather events listed above. However, the list of extreme weather events above is not exclusive. Extreme weather events may include potential weather events which may be rare or record-breaking weather events such as high winds or hail. Forecasting one or more extreme weather events 106 may include forecasting the probability and severity of a single or plurality of extreme weather events for a given year or a desired time frame.

Forecasting one or more extreme weather event 106 may include retrieving social analytics 107, historical weather data 108, and historical weather-related damage data 109. Social analytics 107 may include news, published in printing, aired on television, or published on the Internet, printed publications, publications posted on the Internet, journals, databases, Internet search engine results, social media postings (e.g., TWITTER postings provided under the trademark TWITTER or FACEBOOK postings provided under the trademark FACEBOOK) live conversations, telephone conversations, or hearsay regarding actual or estimated damage to a structure that may affect a supply chain performance. Historical weather data 108 and historical weather-related damage data 109 may be used to predict an extent of damage and a rate of recovery of a supply chain element from an extreme weather event.

Social analytics 107 may be used to determine an extent of damage to a supply chain element from an extreme weather event and to estimate a time to repair and/or restore a supply chain element to normal operation. Social analytics 107 may be used to supplement the forecasted one or more extreme weather event 106 by including actual damage data that may have occurred to a supply chain element. For example, a forecasted hurricane may include predicted flooding which may adversely affect a supply chain element which uses a particular road to transport goods by reducing the speed that goods may be transported on the particular road. Social analytics 107 may supplement the predicted damage with actual damage caused by the hurricane by including, for example, fallen trees blocking traffic flow on the particular road. However, social analytics 107 is not limited to the example disclosed above.

Forecasting one or more extreme weather events 106 may include predicting a probability of severe summer storms for each year within a desired time frame. For example, referring to FIG. 4C, forecasting one or more extreme weather events 106 indicates that the probability of summer storms occurring in year 15 in the vegetable farm of the raw material producer 203 is between 0% and 5%. However, the probability of summer storms occurring in the vegetable farm of the raw material producer 203 in year 27 is between 5% and 15%.

The method includes simulating a second supply chain performance 110 using the supply chain model 102 and the forecasted one or more extreme weather events 106. The simulated second supply chain performance 110 may mimic an operation of a supply chain element (e.g., the production of vegetables that may be procured from the vegetable farm of the raw material producer 203) under one or more extreme weather events 106, indicating how the supply chain element, for example, the vegetable farm of the raw material producer 203, may perform when subjected to the forecasted one or more extreme weather events 106. The second supply chain performance 110 may simulate short-term effects of the one or more extreme weather events 106, associated with climate change.

Simulating a second supply chain performance 110 may also include simulating a supply chain element's inventory turns, cycle time, fill rate, perfect order rate, back order rate, rate or return, or the like.

FIG. 4D illustrates a simulated second supply chain performance 110, indicating the effect of a severe summer storm (e.g., an extreme weather event) on vegetables that may be produced and procured from the raw material producer 203 using a forecasted extreme weather event 106 (e.g., summer storms and the probability of occurrence thereof), and the supply chain model 102. For example, according to the simulated second supply chain performance 110, approximately 200 tons of vegetables may be produced and procured from the raw material producer 203 in year 15. However, between 100 tons and 200 tons of vegetables may be produced by and procured from the raw material producer 203 in year 30.

According to an exemplary embodiment of the inventive concept, a score for the supply chain performance 111 may be determined in light of the received GCCM 101 based on the first and second supply chain performance simulations 105 and 110. The score for the supply chain performance 111 may be probabilistic. For example, the score for the supply chain performance 111 may include a probability of distribution. Referring to FIG. 4E, a combined effect on vegetable order fill rate, based on the first and second supply chain performance simulations 105 and 110, may be determined. For example, a vegetable order fill rate of the raw material producer 203 may be approximately 80% in year 2030. Accordingly a score for the raw material producer 203 may be determined using the vegetable order fill rate of the raw material producer 203. However, a score for the supply chain performance 111 may not be limited to an order fill rate for a particular supply chain element. The score for the supply chain performance 111 may be based on a probability of a vegetable fill rate below 80%, inventory turns, cycle time, fill rate, perfect order rate, back order rate, rate or return, or the like. However, the first score for the supply chain performance 111 is not limited to the above examples. Further, the score for the supply chain performance 111 may be computed for each individual supply chain element of the supply chain model 102.

As an optional step, a user may be alerted (e.g., an alert may be generated) based on the score for the supply chain performance 111 reaching or exceeding a predetermined threshold.

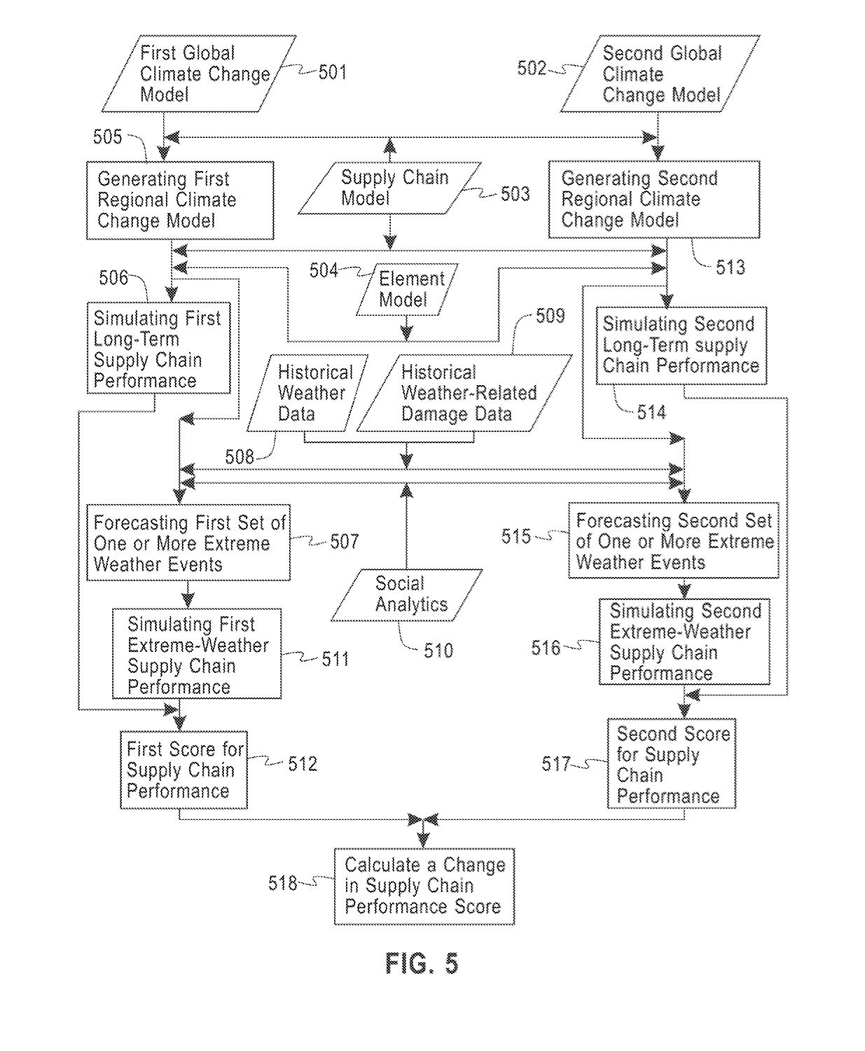

FIG. 5 illustrates a flow chart of a method for predicting effects of climate change on a supply chain performance according to an exemplary embodiment of the inventive concept. Description of elements already described such as the GCCM, the supply chain model, the element model, the regional climate model, or the like, will be omitted for brevity.

A method for predicting effects of climate change on a supply chain performance, according to an exemplary embodiment of the inventive concept, may include receiving a first and a second GCCM, each of which may model (e.g., predict) global climate over time. Information regarding what a supply chain model may include and how it may operate, and an element model which may be used to indicate how the supply chain model may perform under the forecasted global climate change may be received.

Using the first GCCM, a first long-term supply chain performance may be simulated to indicate how the supply chain may perform under global climate change as predicted by the first GCCM. A first extreme-weather supply chain performance may be simulated to indicate how the supply chain may perform under extreme weather, predicted using the first GCCM. A first score for the supply chain performance, using the first GCCM, may be based on the first long-term and first extreme-weather supply chain performances.

Similarly, a second score for the supply chain performance may be determined for the same supply chain by simulating a second long-term and a second extreme-weather performance using the second GCCM.

A change in supply chain performance score, indicating a change in the supply chain performance, may be determined using the first and second scores for the first and second supply chain performances.

Referring to FIG. 5, FIG. 2, FIG. 3, and FIGS. 4A to 4E, according to an exemplary embodiment of the inventive concept, the method includes receiving a first GCCM 501 and a second GCCM 502 modeling global climate over time. The exemplary method also includes receiving a supply chain model 503 modeling procurement and/or production of at least one product from at least one location and at least one element model 504 modeling how a change in local weather affects the procurement of the at least one product. The supply chain model 503 may model procurement and/or production of vegetables from the physical location of the vegetable farm of the raw material producer 203. The element model 504 may model how a change in local weather may affect the procurement or production of vegetables from the raw material producer 203. An element model may be similar to the element model illustrated in FIG. 3 and may be created manually or by an engineering or scientific study.

The method includes generating a first regional climate change model 505 modeling local weather for the at least one location of the supply chain model 503 based on the first GCCM 501. The first regional climate change model 505 may be generated by downscaling the first GCCM 501 and may include estimates for temperature and precipitation. For example, the first regional climate change model 505 may include temperatures and precipitation for a desired year or time frame for the vegetable farm of the raw material producer 203.

The method includes simulating a first long-term supply chain performance 506 using the supply chain model 503, the at least one element model 504, and the first regional climate model 505. Simulating the first long-term supply chain performance 506 is similar to simulating the first supply chain performance 105 described above. Simulating the first long-term supply chain performance 505 may include simulating discrete events and predicting how a supply chain or a supply chain element may perform with demand and supply variability, and with changes in weather. Referring to FIG. 4B, the first long-term supply chain performance 506 may be simulated to predict the effect of rainfall change on summer produce output of the vegetable farm of the raw material producer 203. For example, the effect of rainfall change on summer produce output of the vegetable farm of the raw material producer 203 may be simulated using the predicted summer season rainfall graph, as shown in FIG. 4A, based on the first regional climate model 505, the element model 504, modeling vegetable production rate based on temperature and rainfall, and the supply chain model 503. The supply chain model 503 indicates that the raw material producer 203 provides 200 tons of vegetables to the first transportation provider 213 each summer, that demand is flat and that the supply chain design is not changed. Referring to FIG. 4B, the simulated first long-term supply chain performance 506 indicates that in year 28, the effect of rainfall change on summer produce may include reducing summer vegetable production of the raw material producer 203 to between 50 tons and 150 tons. The simulated first long-term performance may also include inventory turns, cycle time, fill rate, perfect order rate, back order rate, rate or return, or the like.

The method includes forecasting a first set of one or more extreme weather events 507 based on the first regional climate change model 505. Forecasting one or more extreme weather events 507 may include retrieving historical weather data 508, historical weather-related damage data 509, and social analytics 510.

Forecasting a first set of one or more extreme weather events 507 may include predicting a probability and a severity of at least one storm or extreme weather event that may occur each year for a selected time frame. For example, referring to FIG. 4C, forecasting a first set of one or more extreme weather events 507 indicates that the probability of summer storms occurring in the vegetable farm of the raw material producer 203's farm in year 15 is between 0% and 5%. However, the probability of summer storms occurring in the vegetable farm of the raw material producer 203 in year 27 is between 7% and 15%.

The method includes simulating a first extreme-weather supply chain performance 511 using the supply chain model 503 and the first forecasted set of one or more extreme weather events 511 (e.g., probability of summer storms occurring in the vegetable farm of the raw material producer 203). Referring to FIG. 4D, simulating a first extreme-weather supply chain performance 511 indicates that between 100 tons and 200 tons of vegetables may be produced by and procured from the raw material producer 203 in year 30. The first extreme-weather supply chain performance 511 may include inventory turns, cycle time, fill rate, perfect order rate, back order rate, rate or return, or the like.

The method includes determining a first score for the supply chain performance 512, in light of the received first GCCM 501, based on the first long-term supply chain performance simulation 506, and the first extreme-weather supply chain performance simulation 511. The score for the supply chain performance 512 may be based on a vegetable order fill rate of the of the raw material producer 203. For example, the order fill rate of the raw material producer 203 may be between 70% and 90% in year 30. However, the first score for the supply chain performance 512 may also be based on inventory turns, cycle time, fill rate, perfect order rate, back order rate, rate or return, or the like. The first score for the supply chain performance 512 may be probabilistic.

The method includes generating a second regional climate change model 513 modeling local weather for the at least one location of the supply chain model 503 based on the second GCCM 502. The second regional climate change model 513 may be generated by downscaling the second GCCM 502. The second regional climate model 513 may include estimates for temperature and precipitation.

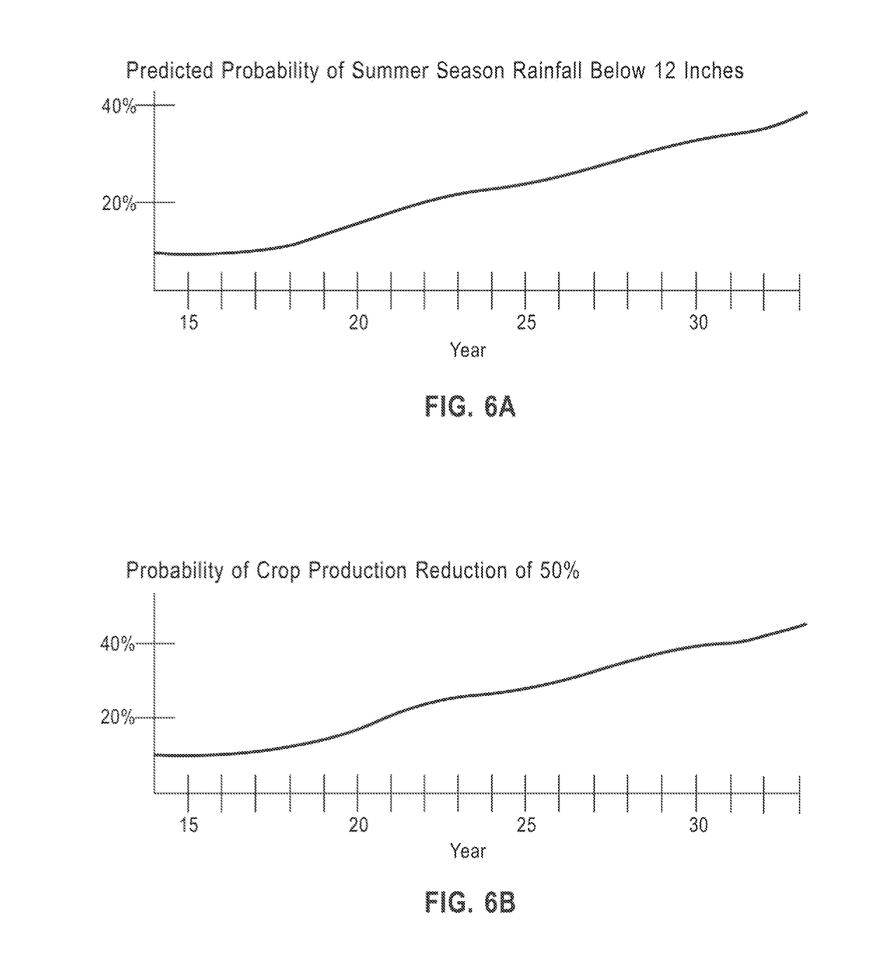

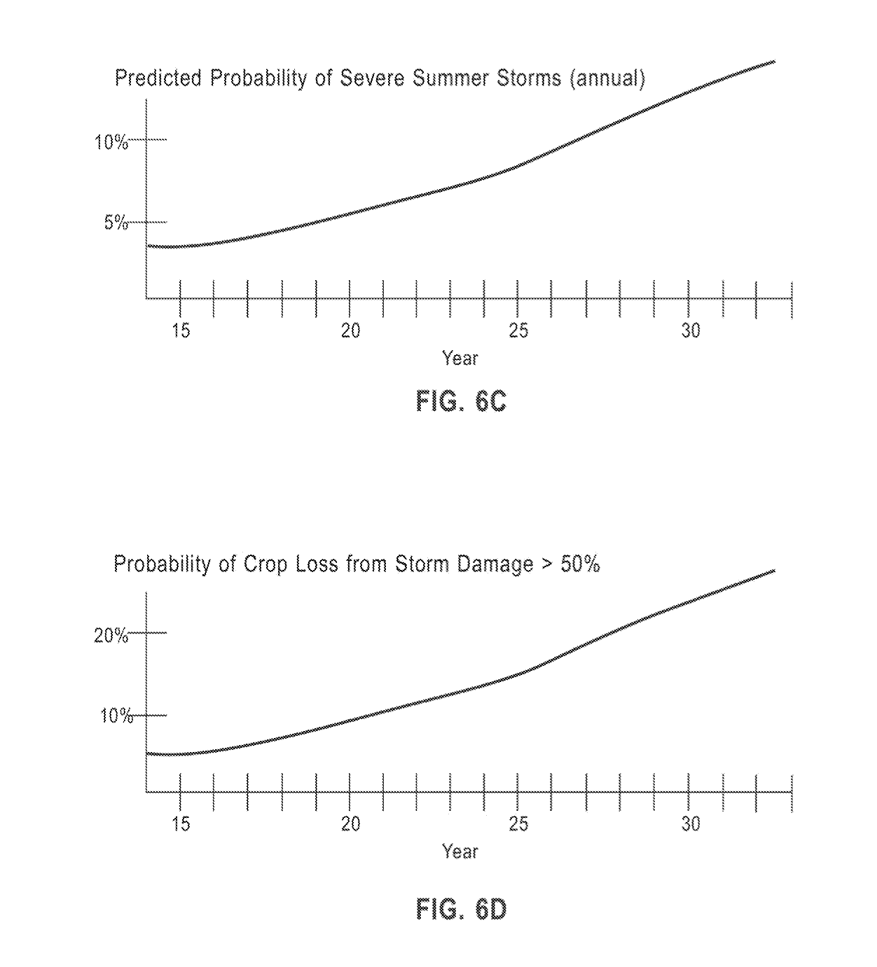

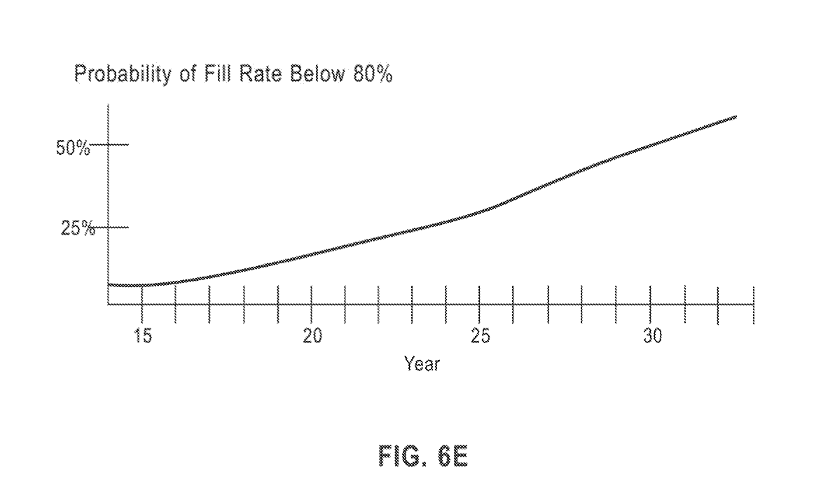

The method includes simulating a second long-term supply chain performance 514 using the supply chain model 503, the at least one element model 504, and the generated second regional climate model 513. Simulating the second long-term supply chain performance 514 may include simulating discrete events and predicting how a supply chain may perform with demand and supply variability and with changes in weather. Referring to FIG. 6B, the second long-term supply chain performance 514 may be simulated to determine a probability of crop production reduction of 50% for the raw material producer 203. A probability of summer season rainfall below 12 inches may be determined based on the second regional climate model 513, as shown in FIG. 6A. The element model 504 may determine a relationship between the probability of crop reduction of 50% and a probability of summer season rainfall below 12 inches. Thus, the second long-term supply chain performance 514 indicates that in year 21, the probability of crop reduction of 50% for the raw material producer 203 is between 10% and 30%. The simulated second long-term supply chain performance 514 may also include inventory turns, cycle time, fill rate, perfect order rate, back order rate, rate or return, or the like.

The method includes forecasting a second set of one or more extreme weather events 515 (e.g., severe summer storms occurring on the vegetable farm of the raw material producer 203) based on the second regional climate 513. The forecasting of an extreme weather event 515 may include retrieving the historical weather data 508, the historical weather-related damage data 509, and the social analytics 510.

Forecasting the second set of one or more extreme weather events 515 may include predicting a probability and a severity of at least one storm that may occur each year at the vegetable farm of the raw material producer 203 for a desired time frame. Referring to FIG. 6C, for example, forecasting the second set of one or more extreme weather events 515 indicates that a probability of severe summer storms occurring on the vegetable farm of the raw material producer 203 in year 20 is between 2% and 8%.

The method includes simulating a second extreme-weather supply chain performance 516 using the supply chain model 503 and the second forecasted set of one or more extreme weather events 515. Referring to FIG. 6D, simulating a second extreme-weather supply chain performance 516 includes simulating a probability of crop loss from storm damage being higher than 50% based on severe summer storms occurring each year. The probability of severe summer storms occurring in a given year may be determined based on the forecasted second set of one or more extreme weather event 515, as shown above. The element model may 504 determine a relationship between the probability of severe summer storms and the probability of crop loss from storm damage being higher than 50% for a desired time frame or for a specific year. For example, as shown in FIG. 6D, simulating a second extreme-weather supply chain performance 516 indicates that the probability of crop loss from storm damage being higher than 50% in year 21 is between 5% and 15%. The second extreme-weather supply chain performance 516 may include inventory turns, cycle time, fill rate, perfect order rate, back order rate, rate or return, or the like.

The method includes determining a second score for the supply chain performance 517, in light of the received second GCCM 502, based on the second long-term supply chain performance simulation 514 and the second extreme-weather supply chain performance simulation 516. Referring to FIG. 6E, determining a second score for the supply chain performance 517 includes determining a probability of the raw material producer 203's vegetable fill rate being below 80% for a given year may be determined. For example, the probability of the fill rate being below 80% in year 23 is between 20% and 30%. The second score for the supply chain performance 517 may also include inventory turns, cycle time, fill rate, perfect order rate, back order rate, rate or return, or the like. The second score for the supply chain performance 517 may be probabilistic.

The method includes calculating a change in supply chain performance score 518 based on the determined first and second scores 512 and 517 for the supply chain performance. Calculating a change in supply chain performance score 518 may include calculating a sensitivity of a supply chain simulation results to a global climate change model.

As an optional step, a user may be alerted (e.g., an alert may be generated) based on the change in supply chain performance score 518 reaching or exceeding a predetermined threshold.

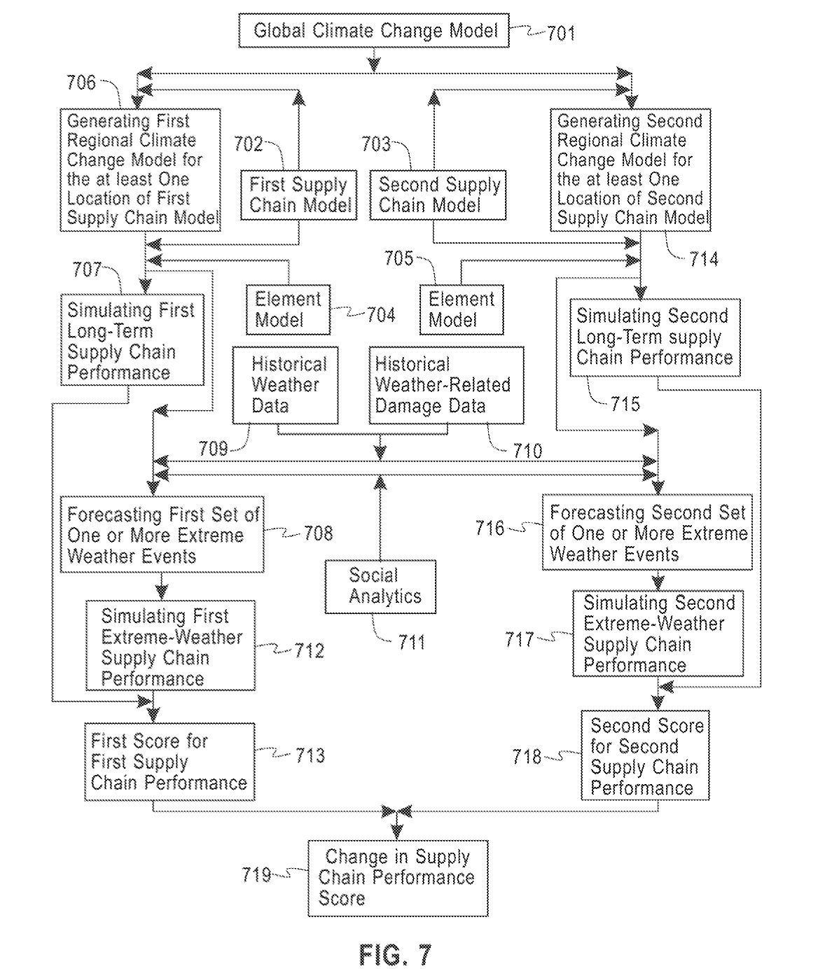

FIG. 7 illustrates a flow chart of a method for predicting effects of climate change on a supply chain performance according to an exemplary embodiment of the inventive concept.

A method for predicting effects of climate change on a supply chain performance, according to an exemplary embodiment of the inventive concept, may include receiving a GCCM which may be used to model (e.g., predict) global climate over time. Information regarding a first and a second supply chain model may be received and an element model corresponding to each of the first and second supply chain models may be received.

A simulated first long-term supply chain performance may indicate how a supply chain may perform using the first supply chain model, the element model corresponding to the first supply chain model and the first regional climate change model based on the GCCM. Similarly, a simulated second long-term supply chain performance may indicate how a supply chain may perform using the second supply chain model, the element model corresponding to the second supply chain model and the a second regional climate change model based on the GCCM.

A first extreme-weather supply chain performance may be simulated to indicate how the supply chain may perform under an extreme weather condition, using the first supply chain model, the element model corresponding to the first supply chain model, and the first regional climate change model. A second extreme-weather supply chain performance may be simulated to indicate how the supply chain may perform under an extreme weather condition, using the second supply chain model, the element model corresponding to the second supply chain model, and the second regional climate change model.

A first score for a first supply chain performance, indicating how the supply chain may perform, may be determined using the first long-term and the first extreme-weather supply performance simulations. Similarly, a second score for a second supply chain performance, indicating how the supply chain may perform, may be determined using the second long-term and the second extreme-weather supply performance simulations.

A change in supply chain performance score, indicating a change in the supply chain performance, may be determined using the first and second scores for the first and second supply chain performances.

The method includes receiving a GCCM 701 modeling global climate over time. The method includes receiving a first supply chain model 702 modeling procurement of at least one product from at least one location and receiving a second supply chain model 703 modeling procurement of at least one product from at least one location. A plurality of supply chain models, such as the first and second supply chain models 702 and 703, may be received because each supply chain model, from the plurality of chain models (e.g., the first and second supply chain models 702 and 703), may include different geographical locations. The method includes receiving at least one element model 704 modeling how a change in local weather affects the procurement of the at least one product of the first supply chain model 702 and receiving at least one element model 705 modeling how a change in local weather affects the procurement of the at least one product of the second supply chain model 703. A vegetable production of the raw material producer 203 may be modeled according to an exemplary embodiment of the inventive concept.

The method includes generating a first regional climate change model 706 modeling local weather for the at least one location of the supply chain model 702 (e.g., the vegetable farm of the raw material producer 203) based on the GCCM 701. The first regional climate change model 706 may be generated by downscaling the GCCM 701. The first regional climate model 706 may include estimates for temperature and precipitation.

The method includes simulating a first long-term supply chain performance 707 using the first supply chain model 702, the at least one element model 704 for the first supply chain model 702, and the generated first regional climate model 706 for the first supply chain model 702. Simulating the first long-term supply chain performance 707 may include simulating discrete events and predicting how a supply chain may perform with demand and supply variability and with changes in weather. Referring to FIG. 4B, simulating the first long-term supply chain performance 707 includes predicting the effect of rainfall change on summer produce output of the raw material producer 203 using the predicted summer season rainfall diagram shown in FIG. 4A. The predicted summer season rainfall diagram shown in FIG. 4A is based on the first regional climate model 706 modeling local weather for the at least one location of the first supply chain model 702. The element model 704 for the first supply chain model 702 may model lettuce farm production rate based on temperature and rainfall. The first supply chain model 702 indicates that the raw material producer 203 provides 200 tons of vegetables to the first transportation provider 213, that demand is flat and the supply chain design is not changed. Referring to FIG. 4B, the simulated first long-term supply chain performance 707 indicates that in year 28, the effect of rainfall change on summer produce may include reducing summer vegetable production of the raw material producer 203 to between 50 tons and 150 tons.

The first long-term supply chain performance 707 may also include inventory turns, cycle time, fill rate, perfect order rate, back order rate, rate or return, or the like.

The method includes forecasting a first set of one or more extreme weather events 708 based on the first generated regional climate model 706. Forecasting one or more extreme weather event 708 may include retrieving historical weather data 709, historical weather-related damage data 710, and social analytics 711. Forecasting a first set of one or more extreme weather events 708 may also include predicting a probability and a severity of at least one storm that may occur each year for a selected time frame. However, the probability of several storms or potential extreme weather events that may occur in a given year may also be predicted. For example, referring to FIG. 4C, forecasting a first set of one or more extreme weather events 708 indicates that the probability of summer storms occurring in the vegetable farm of the raw material producer 203 farm in year 15 is between 0% and 5%. However, the probability of summer storms occurring in the vegetable farm of the raw material producer 203 year 27 is between 7% and 15%.

The method includes simulating a first extreme-weather supply chain performance 712 using the first supply chain model 702 and the forecasted first set of one or more extreme weather events 708. Referring to FIG. 4D, simulating a first extreme-weather supply chain performance 712 indicates that between 100 tons and 200 tons of vegetables may be produced by and procured from the raw material producer 203 in year 30.

The first extreme-weather supply chain performance 712 may include inventory turns, cycle time, fill rate, perfect order rate, back order rate, rate or return, or the like.

The exemplary method includes determining a first score for the first supply chain performance 713, in light of the received GCCM 701, based on the first long-term supply chain performance 707 and the first extreme-weather supply chain performance 712. Referring to FIG. 4E, a combined effect on order fill rate, may be determined. The first score for the first supply chain performance 713 may be based on a vegetable order fill rate of the of the raw material producer 203. For example, the order fill rate of the raw material producer 203 may be between 70% and 90% in year 30. The first score for the first supply chain performance 713 may be probabilistic.

The first score for the first supply chain performance 713 may be based on inventory turns, cycle time, fill rate, perfect order rate, back order rate, rate or return, or the like.

The method includes generating a second regional climate change model 714 modeling local weather for the at least one location of the second supply chain model 703 (e.g., the vegetable farm of the raw material producer 203) based on the GCCM 701. A plurality of regional climate models, such as the first and second regional climate change models 706 and 714, may be created because the supply chain models 702 and 703 may include different geographical locations. The second regional climate change model 714 may be generated by downscaling the GCCM 701. The second regional climate model 714 may include estimates for temperature and precipitation.

The method includes simulating a second long-term supply chain performance 715 using the second supply chain model 703, the at least one element model 705 for the second supply chain model 703, and the generated second regional climate model 714. Simulating the second long-term supply chain performance 714 may include simulating discrete events and predicting how a supply chain may perform with demand and supply variability and with changes in weather. Referring to FIG. 6B, simulating the second long-term supply chain performance 715 may indicate a probability of crop production reduction of 50% of the raw material producer 203 for a given year. A probability of summer season rainfall below 12 inches may be determined based on the second regional climate model 714, as shown in FIG. 6A. The element model 705 for the second supply chain model 703 may determine a relationship between the probability of crop production reduction of 50% and a probability of summer season rainfall below 12 inches. Thus, the probability of crop production reduction of 50% may be simulated using the second regional climate model 714 and the element model 705 for the second supply chain model 703. For example, in year 21, the probability of crop production reduction of 50% is between 10% and 30%.

The simulated second long-term supply chain performance 715 may also include inventory turns, cycle time, fill rate, perfect order rate, back order rate, rate or return, or the like.

The method includes forecasting a second set of one or more extreme weather events 716 (e.g., severe summer storms occurring in the vegetable farm of the raw material producer 203) based on the second generated regional climate model 714. The forecasting of an extreme weather event 716 may include retrieving historical weather data 709, historical weather-related damage data 710, and social analytics 711.

Forecasting the second set of one or more extreme weather events 716 may also include predicting a probability and a severity of at least one storm or other potential extreme weather event that may occur each year for a selected time frame. However, the probability of several storms or potential extreme weather events that may occur in a given year may also be predicted. Referring to FIG. 6C, for example, forecasting the second set of one or more extreme weather events 716 indicates that the probability of severe summer storms occurring in the raw material producer 203's vegetable farm in year 20 is between 2% and 8%.

The method includes simulating a second extreme-weather supply chain performance 717 using the second supply chain model 703 and the forecasted second set of one or more extreme weather events 716. Referring to FIG. 6D, a probability of the raw material producer 203's crop loss from storm damage being higher than 50% may be simulated using the determined probability of severe summer storms occurring each year, as shown in FIG. 6C, and the second supply chain model 703. For example, as shown in FIG. 6D, simulating the second extreme-weather supply chain performance 717 indicates that the probability of crop loss from storm damage being higher than 50% in year 21 is between 5% and 15%.

The second extreme-weather supply chain performance 717 may also simulate inventory turns, cycle time, fill rate, perfect order rate, back order rate, rate or return, or the like.

The method includes determining a second score for the second supply chain performance 718, in light of the received GCCM 701, based on the second long-term supply chain performance 715 and the second extreme-weather supply chain performance 717. Referring to FIG. 6E, determining a second score for the second supply chain performance 718 includes determining a probability of a fill rate below 80% of the vegetable order quantity for the raw material producer 203 for a given year may be determined. For example, the probability of a fill rate below 80% in year 23 is between 20% and 30%. The second score for the second supply chain performance 718 may be probabilistic.

The second score for the second supply chain performance 718 may be based on inventory turns, cycle time, fill rate, perfect order rate, back order rate, rate or return, or the like.

As an optional step, a user may be alerted (e.g., an alert may be generated) based on the second score for the second supply chain performance 718 reaching or exceeding a predetermined threshold.

The method includes calculating a change in supply chain performance score 719 based on the first and second scores for the first and second supply chain performances 713 and 718. The change in supply chain performance score 719 may be used to compare how two or more different supply chain models (e.g., the first and second supply chain models 702 and 703) may perform under the effects of climate change.

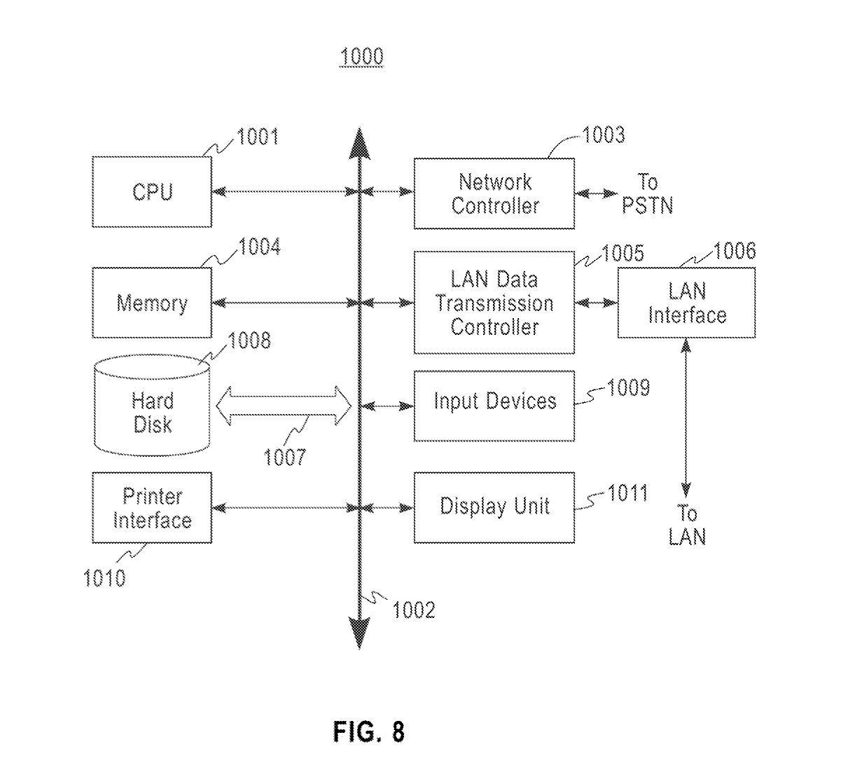

FIG. 8 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

While the present invention has been particularly shown and described with reference to exemplary embodiments thereof, it will be understood by those of ordinary skill in the art that various changes in form and detail may be made therein without departing from the spirit and scope of the present invention.

What is claimed is:

1. A method for predicting effects of climate change on supply chain performance, comprising:
receiving a global climate change model modeling global climate over time;
receiving a supply chain model modeling procurement of at least one product from at least one location;
receiving at least one element model modeling how a change in local weather affects the procurement of the at least one product;
generating a regional climate model modeling local weather for the at least one location based on the received global climate model;
simulating a first supply chain performance using the supply chain model, the received at least one element model and the generated regional climate model;
forecasting one or more extreme weather events based on the generated regional climate model;
simulating a second supply chain performance using the supply chain model and the forecasted one or more extreme weather events; and
determining a score for the supply chain performance in light of the received global climate change model based on the first and second supply chain performance simulations.

2. The method of claim 1, wherein generating the regional climate model based on the received global climate model includes downscaling the global climate model.

3. The method of claim 1, wherein the regional climate model includes estimates for temperature and precipitation and the at least one element model predicts effects on the procurement of the at least one product for the estimated temperature and precipitation.

4. The method of claim 1, wherein the forecasting of the one or more extreme weather events includes calculating a probability of occurrence and probability of severity for each of a list of potential extreme weather events, and wherein the score for the supply chain performance is probabilistic.

5. The method of claim 4, wherein the list of potential extreme weather events includes cyclone, tornado, hurricane, avalanche, blizzard, drought, or flood.

6. The method of claim 1, wherein the forecasting of the one or more extreme weather events includes retrieving historical weather data and retrieving historical weather-related damage data.

7. The method of claim 1, wherein the forecasting of the one or more extreme weather events includes retrieving social analytics.

8. A method for predicting effects of climate change on supply chain performance, comprising:
receiving a first global climate change model modeling global climate over time;
receiving a second global climate change model modeling global climate over time;
receiving a supply chain model modeling procurement of at least one product from at least one location;
receiving at least one element model modeling how a change in local weather affects the procurement of the at least one product;
generating a first regional climate model modeling local weather for the at least one location based on the received first global climate model;
generating a second regional climate model modeling local weather for the at least one location based on the received second global climate model;
simulating a first long-term supply chain performance using the supply chain model, the received at least one element model and the generated first regional climate model;
simulating a second long-term supply chain performance using the supply chain model, the received at least one element model and the generated second regional climate model;
forecasting a first set of one or more extreme weather events based on the generated first regional climate model;
forecasting a second set of one or more extreme weather events based on the generated second regional climate model;
simulating a first extreme-weather supply chain performance using the supply chain model and the first forecasted set of one or more extreme weather events;
simulating a second extreme-weather supply chain performance using the supply chain model and the second forecasted set of one or more extreme weather events;
determining a first score for the supply chain performance in light of the received first global climate change model based on the first long-term supply chain performance and the first extreme-weather supply chain performance;
determining a second score for the supply chain performance in light of the received second global climate change model based on the second long-term supply chain performance and the second extreme-weather supply chain performance; and
calculating a change in supply chain performance score based on the determined first and second scores for the supply chain performance.

9. The method of claim 8, wherein calculating a change in supply chain performance score includes calculating a sensitivity of a supply chain simulation results to a global climate change model.

10. The method of claim 8, wherein generating the regional climate models based on the received global climate models includes downscaling the global climate models.

11. The method of claim 8, wherein the regional climate models include estimates for temperature and precipitation and the at least one element model predicts effects on the procurement of the at least one product for the estimated temperature and precipitation.

12. The method of claim 8, wherein the forecasting of the one or more extreme weather events includes calculating a probability of occurrence and probability of severity for each of a list of potential extreme weather events, wherein the first score for the supply chain performance is probabilistic and second score for the supply chain performances is probabilistic.

13. The method of claim 8, wherein the forecasting of the one or more extreme weather events includes retrieving historical weather data and retrieving historical weather-related damage data.

14. The method of claim 8, wherein the forecasting of the one or more extreme weather events includes retrieving social analytics.

15. A method for predicting effects of climate change on supply chain performance, comprising:
receiving a global climate change model modeling global climate over time;
receiving a first supply chain model modeling procurement of at least one product from at least one location;
receiving a second supply chain model modeling procurement of at least one product from at least one location;
receiving at least one element model modeling how a change in local weather affects the procurement of the at least one product of the first supply chain model;
receiving at least one element model modeling how a change in local weather affects the procurement of the at least one product of the second supply chain model;
generating a first regional climate model modeling local weather for the at least one location of the first supply chain model based on the received global climate model;
generating a second regional climate model modeling local weather for the at least one location of the second supply chain model based on the received global climate model;
simulating a first long-term supply chain performance using the first supply chain model, the received at least one element model for the first supply chain model and the generated first regional climate model;
simulating a second long-term supply chain performance using the second supply chain model, the received at least one element model for the second supply chain model and the generated second regional climate model;
forecasting a first set of one or more extreme weather events based on the first generated regional climate model;
forecasting a second set of one or more extreme weather events based on the second generated regional climate model;
simulating a first extreme-weather supply chain performance using the first supply chain model and the forecasted first set of one or more extreme weather events;
simulating a second extreme-weather supply chain performance using the second supply chain model and the forecasted second set of one or more extreme weather events;
determining a first score for the first supply chain performance in light of the received global climate change model based on the first long-term supply chain performance and the first extreme-weather supply chain performance;
determining a second score for the second supply chain performance in light of the received global climate change model based on the second long-term supply chain performance and the second extreme-weather supply chain performance; and
calculating a change in supply chain performance score based on the determined first and second scores for the supply chain performance.

16. The method of claim 14, wherein generating the regional climate models based on the received global climate model includes downscaling the global climate model, and wherein the at least one location of the first supply chain model includes a geographical location that is different from a geographical location of the at least one location of the second supply chain model.

17. The method of claim 14, wherein the regional climate models include estimates for temperature and precipitation and the at least one element model predicts effects on the procurement of the at least one product for the estimated temperature and precipitation.

18. The method of claim 14, wherein the forecasting of the one or more extreme weather events includes calculating a probability of occurrence and probability of severity for each of a list of potential extreme weather events, wherein the first score for the first supply chain performance is probabilistic and the second score for the second supply chain performance is probabilistic.

19. The method of claim 14, wherein the forecasting of the one or more extreme weather events includes retrieving historical weather data and retrieving historical weather-related damage data.

20. The method of claim 14, wherein the forecasting of the one or more extreme weather events includes retrieving social analytics.
